(19) United States
(12) Patent Application Publication
(10) Pub. No.: US 2021/0358297 A1
(43) Pub. Date: Nov. 18, 2021

(54) VIOLATOR IDENTIFICATION DEVICE, VIOLATOR IDENTIFICATION SYSTEM, VIOLATOR IDENTIFICATION METHOD, AND PROGRAM

(71) Applicant: MITSUBISHI HEAVY INDUSTRIES MACHINERY SYSTEMS, LTD., Hyogo (JP)

(72) Inventors: Shinichi MASUMOTO, Kobe-shi (JP); Kazuyoshi KITAJIMA, Kobe-shi (JP); Tatsuya HIGUCHI, Tokyo (JP)

(21) Appl. No.: 17/268,301

(22) PCT Filed: Aug. 15, 2018
(86) PCT No.: PCT/JP2018/030362

§ 371 Date: Feb. 12, 2021

(51) Int. Cl. G08G 1/017; G08G 1/054; G06K 9/00

(52) U.S. Cl. CPC G08G 1/0175; G08G 1/054; G06K 2209/23; G06K 9/00288; G06K 2209/15; G06K 9/00664

(57) ABSTRACT

A violator identification device (10) that is configured to identify a violator associated with travel of a vehicle includes: a vehicle identification information acquiring unit (100) configured to acquire vehicle identification information which is able to identify the vehicle in which the violator rides from an image captured by a roadside camera (125); a personal information acquiring unit (103) configured to acquire personal information correlated with the vehicle identification information from a database (13) which is provided in a system that is configured to provide services for vehicles; and an output unit (104) configured to output violation information in which the image and the personal information are correlated.

### TECHNICAL FIELD

The present invention relates to a violator identification device, a violator identification system, a violator identification method, and a program.

### BACKGROUND ART

In facilities that provides services associated with vehicles such as toll roads, regulations (for example, speed, weight, vehicle height, and vehicle length) associated with traveling of vehicles are determined for users to safely use the facilities. A regulation organization such as the police maintains safety in the facilities by identifying a violative vehicle and a violator violating such regulations and imposing a penalty thereon.

For example, Patent Document 1 discloses a system that identifies a vehicle registration number of a violative vehicle from a number plate (license plate) image of a vehicle imaged by a camera to regulate the violative vehicle on a toll road.

### CITATION LIST

### Patent Literature

### [Patent Document 1]

Japanese Unexamined Patent Application, First Publication No. 2013-200845

### SUMMARY OF INVENTION

### Technical Problem

When a violative vehicle is detected, a regulation organization identifies an owner of the violative vehicle and issues a notice associated with a hearing, examination, and a penalty to the owner. At this time, in the system according to the related art, the regulation organization needs to perform a procedure of asking a vehicle registration information providing organization that provides information of vehicles registered in the nation (such as vehicle registration numbers and names and addresses of owners) about the vehicle registration number of the violative vehicle and acquiring personal information of the owner. This procedure is complicated and causes an increase in labor of the regulation organization.

The invention was made in consideration of the aforementioned circumstances and provides a violator identification device, a violator identification system, a violator identification method, and a program that can decrease the labor associated with regulation of a violative vehicle and a violator.

### Solution to Problem

In order to achieve the aforementioned objective, the invention employs the following configurations.

According to a first aspect of the invention, there is provided a violator identification device (10) that is configured to identify a violator associated with travel of a vehicle, the violator identification device including: a vehicle identification information acquiring unit (100) configured to acquire vehicle identification information which is able to identify the vehicle in which the violator rides from an image captured by a roadside camera (125); a personal information acquiring unit (103) configured to acquire personal information correlated with the vehicle identification information from a database (13) which is provided in a system that is configured to provide services for vehicles; and an output unit (104) configured to output violation information in which the image and the personal information are correlated.

With this configuration, the violator identification device can acquire personal information registered in an existing service and output the acquired personal information as violation information. Accordingly, since the violator identification device can skip a complicated procedure for causing a device user to identify an owner of a violative vehicle, it is possible to decrease the labor associated with regulation of a violative vehicle and a violator.

According to a second aspect of the invention, in the violator identification device (10) according to the first aspect, the personal information acquiring unit is configured to request the database to provide the personal information correlated with the vehicle identification information.

With this configuration, since the violator identification device can automatically request the database and acquire personal information when a violation has been detected, it is possible to further decrease the labor for identifying an owner of a violative vehicle.

According to a third aspect of the invention, in the violator identification device (10) according to the first or second aspect, the image includes a face image of the violator.

With this configuration, the violator identification device can provide violation information including a face image of a violator to a regulation organization as evidence for determining whether an owner of a vehicle is the same person as a driver.

According to a fourth aspect of the invention, the violator identification device (10) according to any one of the first to third aspects may further include a violation detecting unit (102) configured to detect violation of the vehicle on the basis of a measurement result including at least one of speed, weight, height, and length of the vehicle measured by a sensor (120, 121, 122, 123).

With this configuration, the violator identification device can automatically detect whether a vehicle has violated at least one of regulation of speed, weight, height, and length.

According to a fifth aspect of the invention, in the violator identification device (10) according to the fourth aspect, the output unit (104) is configured to output the violation information further including the measurement result measured by the sensor.

Since the violator identification device outputs violation information including the measurement result and the image acquired at the time of violation, a regulation organization can use the violation information as evidence of the violation.

According to a sixth aspect of the invention, there is provided a violator identification system that is configured to identify a violator associated with travel of a vehicle, the violator identification system (1) including: a roadside camera (125) configured to capture an image including the violator and the vehicle in which the violator rides; a vehicle identification information acquiring unit (100) configured to acquire vehicle identification information which is able to identify the vehicle in which the violator rides from the image captured by the roadside camera (125); a personal information acquiring unit (103) configured to acquire personal information correlated with the vehicle identification information from a database (13) which is provided in a system that is configured to provide services for vehicles; and an output unit (104) configured to output violation information in which the image and the personal information are correlated.

According to a seventh aspect of the invention, there is provided a violator identification method of identifying a violator associated with travel of a vehicle, the violator identification method including: a vehicle identification information acquiring step of acquiring vehicle identification information which is able to identify the vehicle in which the violator rides from an image captured by a roadside camera (125); a personal information acquiring step of acquiring personal information correlated with the vehicle identification information from a database (13) which is provided in a system that is configured to provide services for vehicles; and an output step of outputting violation information in which the image and the personal information are correlated.

According to an eighth aspect of the invention, there is provided a program causing a computer (900) of a violator identification device (10) that is configured to identify a violator associated with travel of a vehicle to perform: a vehicle identification information acquiring step of acquiring vehicle identification information which is able to identify the vehicle in which the violator rides from an image captured by a roadside camera (125); a personal information acquiring step of acquiring personal information correlated with the vehicle identification information from a database (13) which is provided in a system that is configured to provide services for vehicles; and an output step of outputting violation information in which the image and the personal information are correlated.

### Advantageous Effects of Invention

With the violator identification device, the violator identification system, the violator identification method, and the program described above, it is possible to decrease the labor associated with regulation of a violative vehicle and a violator.

### BRIEF DESCRIPTION OF DRAWINGS

FIG. 1 is a diagram illustrating an overall configuration of a violator identification system according to an embodiment of the invention.

FIG. 2 is a diagram illustrating an example of personal information according to the embodiment of the invention.

FIG. 3 is a diagram illustrating a functional configuration of the violator identification system according to the embodiment of the invention.

FIG. 4 is a flowchart illustrating an example of a process which is performed by the violator identification system according to the embodiment of the invention.

FIG. 5 is a diagram illustrating an example of violation information according to the embodiment of the invention.

FIG. 6 is a diagram illustrating a hardware configuration of a violator identification device according to the embodiment of the invention.

FIG. 7 is a diagram illustrating an overall configuration of a violator identification system according to another embodiment of the invention.

### DESCRIPTION OF EMBODIMENTS

Hereinafter, a violator identification system 1 according to an embodiment of the invention will be described with reference to the accompanying drawings.

(Overall Configuration)

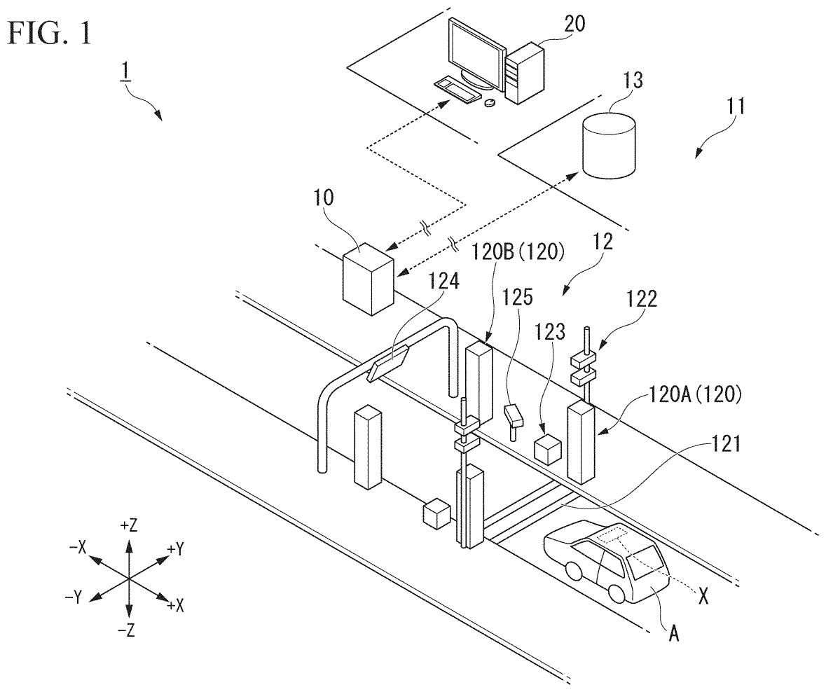

FIG. 1 is a diagram illustrating an overall configuration of a violator identification system according to an embodiment of the invention.

The violator identification system 1 is a system that identifies a violator associated with travel of a vehicle and is provided in a facility that provides services for vehicles.

Examples of the facility that provides services for vehicles include a toll road and a parking lot. In this embodiment, as illustrated in FIG. 1, it is assumed that the violator identification system 1 is provided in a tollbooth of a toll road.

Examples of violation associated with travel of a vehicle include actions of violating regulations of speed, weight, vehicle height, vehicle length, and the like of a vehicle which are determined by laws or a manager of the facility.

As illustrated in FIG. 1, the violator identification system 1 includes a violator identification device 10 and a toll collection system 11.

The violator identification device 10 detects whether a vehicle A arriving at a tollbooth of a toll road has violated regulations. The violator identification device 10 identifies a violator who is a driver of the vehicle A when it is detected that the vehicle A has violated regulations. The violator identification device 10 transmits information on the identified violator to a terminal device 20 which is provided in a regulation organization.

The toll collection system 11 is a system that collects a toll from the vehicle A using the toll road. The vehicle A using the toll road travels in a lane connecting a ordinary road to the toll road in a tollbooth which is provided at an entrance or an exit of the toll road.

As illustrated in FIG. 1, the toll collection system 11 includes a roadside device 12 that is provided on a roadside of the lane and a database 13 that is provided in a remote place.

The roadside device 12 is a device group that collects tolls according to model types of vehicles A arriving at the tollbooth. In this embodiment, the roadside device 12 is also used as a device group that is used for the violator identification device 10 to acquire various types of information for detecting violation of a vehicle A and identifying a violator.

The roadside device 12 includes a vehicle speed sensor 120, a weight sensor 121, a vehicle height detector 122, a vehicle length detector 123, a roadside radio communication device 124, and a roadside camera 125.

The vehicle speed sensor 120 is a sensor that measures the speed of a vehicle A arriving at the tollbooth. For example, the vehicle speed sensor 120 according to this embodiment includes a plurality of vehicle detectors 120A and 120B which are provided in an existing toll collection system 11 as illustrated in FIG. 1. The vehicle detectors 120A and 120B are devices that detect whether a vehicle A is present at a predetermined detection position.

The vehicle speed sensor 120 measures the speed of a vehicle A on the basis of a period of time until the vehicle detector 120B located downstream (the +X side in FIG. 1) detects the vehicle A after the vehicle detector 120A located upstream (the −X side in FIG. 1) has detected the vehicle A.

In another embodiment, the vehicle speed sensor 120 may be a radar for speed measurement.

The weight sensor 121 is a sensor that measures the weight of a vehicle A arriving at the tollbooth. For example, the weight sensor 121 according to this embodiment is a tread board which is provided in the existing toll collection system 11 as illustrated in FIG. 1. The weight sensor 121 (the tread board) detects pressing by tires of the vehicle A and measures the weight (an axle load) of the vehicle A.

In another embodiment, a sensor that measures the total weight of a vehicle A may be provided as the weight sensor 121.

The vehicle height detector 122 is a sensor that measures the height of a vehicle A arriving as the tollbooth. In this embodiment, the vehicle height detector 122 employs a vehicle height detector which is provided in the existing toll collection system 11.

The vehicle length detector 123 is a sensor that measures the length of a vehicle A arriving at the tollbooth. In this embodiment, the vehicle length detector 123 employs the vehicle length detector which is provided in the existing toll collection system 11.

The roadside radio communication device 124 performs a radio communication process with a medium X which is installed on a vehicle A using radio communication technology such as dedicated short-range communications (DSRC) or radio frequency identifier (RFID). The roadside radio communication device 124 performs a process of collecting a toll of the toll road from the vehicle A on the basis of an electronic toll collection system (ETC) (registered trademark; also referred to as an “automatic toll collection system”).

The medium X is a device in which information associated with the vehicle A or an owner of the vehicle A is stored and examples thereof include an on-board unit and an IC tag. Information stored in the medium X (hereinafter also referred to as “medium information”) includes, for example, vehicle identification information for identifying the vehicle A and identification information for identifying the medium X. The vehicle identification information is number plate information (a classification number and a vehicle number marked on a number plate) of the vehicle A. The identification information includes an on-board unit ID, a user ID or the like. The medium information may include other information such as a vehicle model classification of the vehicle A.

The roadside device 12 may include a manned booth in which a collector is present or an automatic toll collector instead of the roadside radio communication device 124 in order to collect a toll from a vehicle A to which the medium X is not attached.

The roadside camera 125 captures an image of a vehicle A arriving at the tollbooth. For example, the roadside camera 125 according to this embodiment is a number plate reader which is provided in the existing toll collection system 11 as illustrated in FIG. 1. An image captured by the roadside camera 125 includes at least a number plate of the vehicle A. The roadside camera 125 according to this embodiment images the number plate attached to the front side of the vehicle A (downstream (the +X side) in a lane direction of the vehicle A) as illustrated in FIG. 1 but is not limited thereto. In another embodiment, the roadside camera 125 may image the number plate attached to the rear side of the vehicle A (upstream (the −X side) in the lane direction of the vehicle A). The roadside camera 125 may include both a downstream camera that images the number plate attached to the front side of the vehicle A and an upstream camera that images the number plate attached to the rear side of the vehicle A.

The roadside camera 125 may capture an image including a face of a driver of the vehicle A. At this time, the roadside camera 125 may set an area including the number plate of the vehicle A and the face of the driver as an imaging area. The roadside camera 125 may include both a camera that images the number plate and a camera that images a face of a driver. In this case, the camera that images the number plate images at least one of the number plates attached to the front side and the rear side of the vehicle A.

A mirror (not illustrated) for reflecting at least one of the number plate and the face of the driver of the vehicle A may be provided on the roadside and the roadside camera 125 may image the number plate and the driver's face which are reflected by the mirror. By employing this configuration, the driver is less likely to be aware of being imaged. In this case, mirrors may be provided in a plurality of positions in consideration of variation of the position of the number plate and the position of the driver with each vehicle.

The roadside camera 125 according to this embodiment captures an image at the time at which the vehicle detector 120A has detected the vehicle A, but is not limited thereto. In another embodiment, the roadside camera 125 may perform imaging and image processing and acquire regularly an image including the number plate. When the number plate and the driver's face are imaged using different cameras, the roadside camera 125 may image the driver's face at the time at which an image including the number plate has been acquired by image processing.

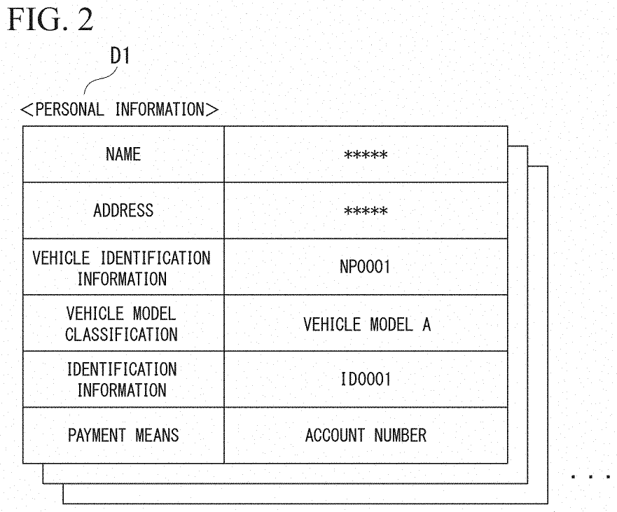

Personal information D1 (FIG. 2) of a plurality of users who use the electronic toll collection system is registered in advance in the database 13.

FIG. 2 is a diagram illustrating an example of personal information according to the embodiment of the invention.

For example, as illustrated in FIG. 2, the personal information D1 is information in which a “name” and an “address” of a user, “vehicle identification information” and a “vehicle model classification” of a vehicle A in which the user rides, “identification information” of a medium X installed on the vehicle A, a “payment means” of a toll, and the like are correlated. The payment means includes an account number of a bank, a credit card number, or the like.

(Functional Configuration)

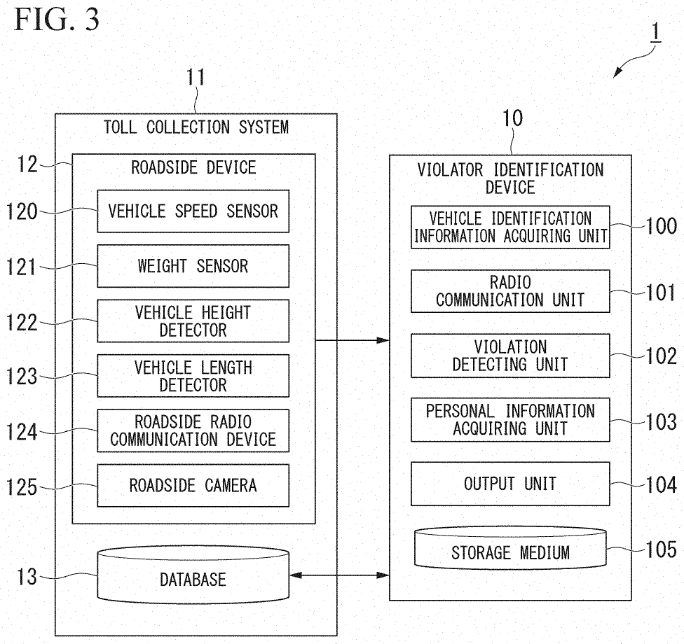

FIG. 3 is a diagram illustrating a functional configuration of the violator identification system according to the embodiment of the invention.

As illustrated in FIG. 3, the violator identification device 10 of the violator identification system 1 includes a vehicle identification information acquiring unit 100, a radio communication unit 101, a violation detecting unit 102, a personal information acquiring unit 103, an output unit 104, and a storage medium 105.

The vehicle identification information acquiring unit 100 acquires vehicle identification information for identifying a vehicle A in which a violator rides from an image captured by the roadside camera 125.

The radio communication unit 101 acquires medium information stored in a medium X of the vehicle A via the roadside radio communication device 124.

The violation detecting unit 102 detects violation of a vehicle A on the basis of a measurement result including at least one of speed, weight, height, and length of the vehicle A measured by the sensors (the vehicle speed sensor 120, the weight sensor 121, the vehicle height detector 122, and the vehicle length detector 123).

The personal information acquiring unit 103 acquires personal information which is correlated with vehicle identification information from a database 13 which is provided in a system that provides services for vehicles A. More specifically, the personal information acquiring unit 103 acquires personal information from the database 13 as a response by transmitting an instruction for requesting the database 13 to provide personal information correlated with vehicle identification information.

The system that provides services for vehicles A is the toll collection system 11 in this embodiment. In another embodiment, the system may be a toll collection system that collects fees of a parking lot.

The output unit 104 outputs violation information in which an image captured by the roadside camera 125, the personal information acquired by the personal information acquiring unit 103, and the measurement result from the sensors are correlated to a terminal device 20 which is provided in a regulation organization. Accordingly, the regulation organization can impose a penalty on a violator on the basis of the violation information collected by the terminal device 20.

Regulation information indicating limit values of speed, weight, height, and length of the vehicle for each toll road is stored in advance in the storage medium 105. Violation information prepared by the output unit 104 or the like may be stored in the storage medium 105.

(Flow of Processes)

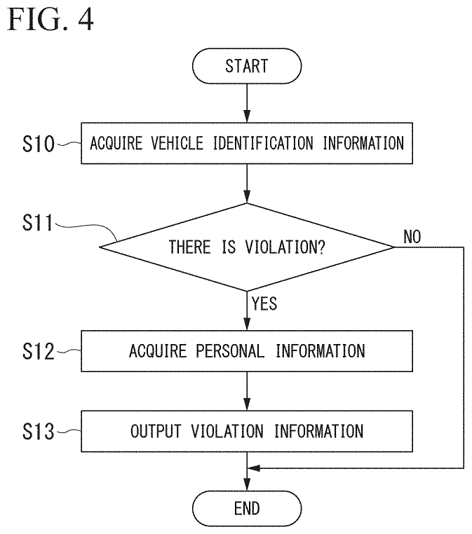

FIG. 4 is a flowchart illustrating an example of a flow of processes which are performed by the violator identification system according to the embodiment of the invention.

An example of a flow of processes through which the violator identification device 10 of the violator identification system 1 detects violation and identifies a violator will be described below with reference to FIG. 4.

When a vehicle A arrives at the tollbooth (the vehicle detector 120A detects presence of a vehicle A), the vehicle identification information acquiring unit 100 acquires vehicle identification information of the vehicle A from an image captured by the roadside camera 125 (Step S10). In this embodiment, the vehicle identification information acquiring unit 100 reads number plate information of the vehicle A (a classification number and a vehicle number marked on the number plate) and acquires the read number plate information as the vehicle identification information by performing predetermined image processing on the image captured by the roadside camera 125.

Then, the violation detecting unit 102 determines whether the vehicle A has violated regulations on the basis of the measurement results measured by the vehicle speed sensor 120, the weight sensor 121, the vehicle height detector 122, and the vehicle length detector 123 (Step S11).

For example, when the speed of the vehicle A measured by the vehicle speed sensor 120 is greater than a limit value (a speed limit) for a speed indicated by regulation information stored in advance in the storage medium 105, the violation detecting unit 102 determines that the vehicle A has violated regulations (Step S11: YES). The violation detecting unit 102 performs the same determination for the weight, the height, and the length of the vehicle A. When the measurement result of at least one of the speed, the weight, the height, and the length is greater than the corresponding limit value, the violation detecting unit 102 determines that the vehicle A has violated regulations (Step S11: YES).

On the other hand, when none of the speed, the weight, the height, and the length of the vehicle A is not greater than the corresponding limit values, the violation detecting unit 102 determines that the vehicle A has not violated regulations (Step S11: NO).

When the measurement results are greater by a predetermined allowable value or more than the limit values in consideration of measurement errors of the sensors or the like, the violation detecting unit 102 may determine that the vehicle A has violated regulations. In this case, an arbitrary value is set as the allowable value for each sensor.

When the violation detecting unit 102 detects that the vehicle A has violated regulations (Step S11: YES), the personal information acquiring unit 103 acquires personal information from the database 13 of the toll collection system 11 (Step S12). At this time, the personal information acquiring unit 103 requests the database 13 to provide personal information correlated with the vehicle identification information (the number plate information) acquired in Step S10.

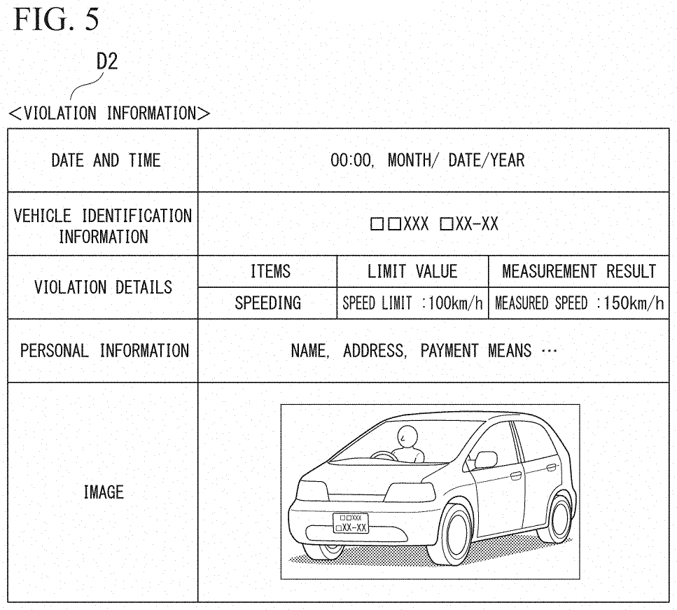

The output unit 104 prepares violation information D2 of the vehicle A (FIG. 5) and outputs the violation information to the terminal device 20 which is provided in the regulation organization (Step S13).

FIG. 5 is a diagram illustrating an example of violation information according to the embodiment of the invention.

As illustrated in FIG. 5, the violation information D2 is information in which “date and time” at which violation has been detected, “vehicle identification information” of the vehicle A, “violation details,” “personal information,” and an “image are correlated.

The vehicle identification information is the number plate information of the vehicle A identified in Step S10.

The violation details are information including the item (speed, weight, height, and length) of which the regulation is determined to be violated in Step S11, the limit value thereof, and the measurement result thereof. For example, as illustrated in FIG. 5, when the vehicle A has violated speeding, information of “speeding,” “speed limit: 100 km/h,” and “measured speed: 150 km/h” is recorded as the item, the limit value, and the measurement result included in the violation details. When the vehicle A has violated regulations for a plurality of items, the output unit 104 may add the plurality of violation details to the violation information D2 or may prepare a plurality of pieces of violation information D2 for the violated items.

The personal information is personal information acquired from the database 13 in Step S12, and includes, for example, a “name,” an “address,” and a “payment means” of an owner of the vehicle A as illustrated in FIG. 5.

The image is an image including the number plate of the vehicle A which is captured by the roadside camera 125.

The image may include a face of a driver. In this case, the image of the number plate and the face image of the driver may be a single image or separate images.

An image including the entire vehicle body of the vehicle A may be additionally included in the image.

The violator identification device 10 repeatedly performs the aforementioned processes when a vehicle A arrives at the tollbooth. Accordingly, the violator identification device 10 can automatically provide violation information including violation details and a number plate of the vehicle A (and an image of a violator) to the regulation organization when it is detected that the vehicle A has violated regulations.

In the example illustrated in FIG. 4, the output unit 104 outputs violation information to the terminal device 20 of the regulation organization when the violation detecting unit 102 detects violation of a vehicle A, but the invention is not limited thereto. In another embodiment, the output unit 104 may store the prepared violation information in the storage medium 105 and output a plurality of pieces of violation information to the terminal device 20 together at a predetermined time.

(Hardware Configuration)

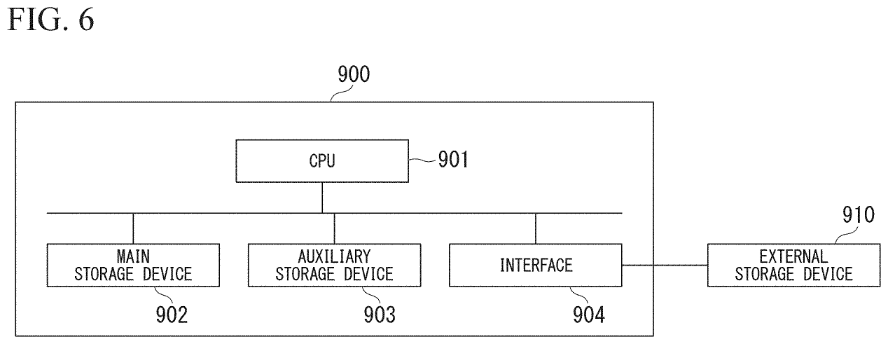

FIG. 6 is a diagram illustrating an example of a hardware configuration of the violator identification device according to the embodiment of the invention.

An example of the hardware configuration of the violator identification device 10 will be described below with reference to FIG. 6.

As illustrated in FIG. 6, a computer 900 includes a CPU 901, a main storage device 902, an auxiliary storage device 903, and an interface 904.

The aforementioned violator identification device 10 is mounted in the computer 900. Operations of the processing units are stored in the form of a program in the auxiliary storage device 903. The CPU 901 reads a program from the auxiliary storage device 903, loads the read program in the main storage device 902, and performs the processes in accordance with the program. The CPU 901 secures a storage area which is used for various processes by the violator identification device 10 in the main storage device 902. The CPU 901 secures a storage area (the storage medium 105) storing data in process in the auxiliary storage device 903 in accordance with the program.

Examples of the auxiliary storage device 903 include a hard disk drive (HDD), a solid state drive (SDD), a magnetic disk, a magneto-optical disc, a compact disc-read only memory (CD-ROM), a digital versatile disc-read only memory (DVD-ROM), and a semiconductor memory. The auxiliary storage device 903 may be an internal medium which is directly connected to a bus of the computer 900 or may be an external medium which is connected to the computer 900 via the interface 904 or a communication line. When the program is transmitted to the computer 900 via the communication line, the computer 900 may load the received program in the main storage device 902 and perform the processes. In at least one embodiment, the auxiliary storage device 903 is a non-transitory tangible storage medium.

The program may be for realizing some of the aforementioned functions.

The program may be a so-called differential file (a differential program) that can realize the aforementioned functions in combination with another program which has been stored in advance in the auxiliary storage device 903.

(Operations and Advantages)

As described above, the violator identification device 10 according to this embodiment is a violator identification device 10 that identifies a violator associated with travel of a vehicle A, the violator identification device including: a vehicle identification information acquiring unit 100 configured to acquire vehicle identification information which is able to identify the vehicle A in which the violator rides from an image captured by a roadside camera 125; a personal information acquiring unit 103 configured to acquire personal information correlated with the vehicle identification information from a database 13 which is provided in a system that provides services for vehicles A; and an output unit 104 configured to output violation information in which the image and the personal information are correlated.

By employing this configuration, the violator identification device 10 can acquire personal information registered in an existing service and output the acquired personal information as violation information. Accordingly, since the violator identification device 10 can skip a complicated procedure for causing a device user to identify an owner of a violative vehicle, it is possible to decrease the labor associated with regulation of a violative vehicle and a violator. The device user is, for example, an operator of a facility that provides a service for vehicles or a regulation organization.

The personal information acquiring unit 103 may request the database 13 to provide the personal information correlated with the vehicle identification information.

By employing this configuration, since the violator identification device 10 can automatically request the database 13 and acquire personal information when a violation has been detected, it is possible to further decrease the labor for identifying an owner of a violative vehicle.

The image may include a face image of the violator.

By employing this configuration, the violator identification device 10 can provide violation information including a face image of a violator to a regulation organization as evidence for determining whether an owner of a vehicle A is the same person as a driver. Accordingly, for example, when a person other than the owner of the vehicle A is driving the vehicle A, it is possible to prevent the owner of the vehicle A having not violated regulations from being punished.

The violator identification device 10 may further include a violation detecting unit 102 configured to detect violation of the vehicle A on the basis of a measurement result including at least one of speed, weight, height, and length of the vehicle A measured by sensors (the vehicle speed sensor 120, the weight sensor 121, the vehicle height detector 122, and the vehicle length detector 123).

By employing this configuration, the violator identification device 10 can automatically detect whether a vehicle A has violated regulation of at least one of speed, weight, vehicle height, and vehicle length.

The output unit 104 may output the violation information further including the measurement result measured by the sensors (the vehicle speed sensor 120, the weight sensor 121, the vehicle height detector 122, and the vehicle length detector 123).

Since the violator identification device 10 outputs violation information including the measurement result and the image acquired at the time of violation, a regulation organization can use the violation information as evidence of the violation.

### Other Embodiments

In the aforementioned embodiment, the violator identification system 1 is provided in a tollbooth of a toll road, but the invention is not limited thereto. A violator identification system 1 according to another embodiment may be applied to, for example, a toll road of a multi-lane free flow type (hereinafter also referred to as a “MLFF type”).

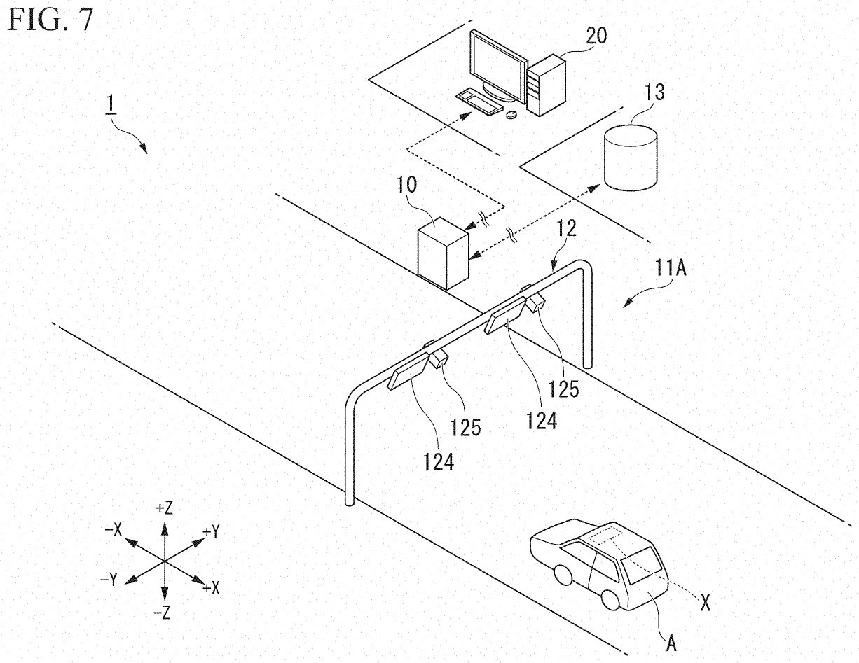

FIG. 7 is a diagram illustrating an overall configuration of a violator identification system according to another embodiment of the invention.

As illustrated in FIG. 7, the violator identification system 1A includes a violator identification device 10 and an MLFF type toll collection system 11A.

The MLFF type toll collection system 11A includes at least a roadside radio communication device 124 and a roadside camera 125 as roadside devices 12.

The functions of the roadside radio communication device 124 are the same as in the aforementioned embodiment.

The roadside camera 125 may be provided on a roadside similarly to the aforementioned embodiment (FIG. 1) or may be provided on a gantry along with the roadside radio communication device 124 as illustrated in FIG. 7. Similarly to the aforementioned embodiment, the roadside camera 125 captures an image including a number plate of a vehicle A. The roadside camera 125 may further capture an image additionally including a face of a driver of the vehicle A.

The roadside camera 125 may normally image vehicles A traveling in a lane and serve as a violation detecting unit that detects violation of the vehicles A. For example, the roadside camera 125 may measure speed, height, and length of a vehicle A from a plurality of images of the vehicle A which are successive in a time series and detect violation of the vehicle A.

The violator identification system 1A can also achieve the same operations and advantages as in the aforementioned embodiment when it is applied to such an MLFF type toll collection system 11A.

While embodiments of the invention have been described above in detail, the invention is not limited thereto unless departing from the technical spirit of the invention and can include modifications in design.

For example, in the aforementioned embodiments, the violator identification device 10 identifies a violator who has violated regulations of speed, weight, height, and length of a vehicle A, but the invention is not limited thereto. In another embodiment, the violator identification device 10 may identify a violator who has not paid a road tax (such as a vehicle tax) which is determined for each nation to use a vehicle A on a public road. In this case, in Step S11 of FIG. 4, the violation detecting unit 102 of the violator identification device 10 may inquire of an organization that manages the road tax about vehicle identification information and ascertain whether the road tax has been paid.

In another embodiment, the violator identification device 10 may identify a person who has illegally used a facility without a medium X installed on a vehicle A as a violator in the facility (a toll road, a parking lot, or the like) in which a user is obligated to attach the medium X to the vehicle A at the time of use of the facility. In this case, when the vehicle identification information acquiring unit 100 has acquired vehicle identification information of the vehicle A in Step S11 of FIG. 4 and the radio communication unit 101 cannot wirelessly communicate with the vehicle A, the violation detecting unit 102 of the violator identification device 10 determines that the vehicle A is a violative vehicle to which the medium X is not attached.

### INDUSTRIAL APPLICABILITY

With the violator identification device, the violator identification system, the violator identification method, and the program described above, it is possible to decrease the labor associated with regulation of a violative vehicle and a violator.

### REFERENCE SIGNS LIST

1 Violator identification system
10 Violator identification device
100 Vehicle identification information acquiring unit
101 Radio communication unit
102 Violation detecting unit
103 Personal information acquiring unit
104 Output unit
105 Storage medium
11, 11A Toll collection system
12 Roadside device
120 Vehicle speed sensor (sensor)
121 Weight sensor (sensor)
122 Vehicle height detector (sensor)
123 Vehicle length detector (sensor)
124 Roadside radio communication device
125 Roadside camera
13 Database
20 Terminal device
A Vehicle
X Medium

1. A violator identification device that is configured to identify a violator associated with travel of a vehicle, the violator identification device comprising:
a vehicle identification information acquiring unit configured to acquire vehicle identification information which is able to identify the vehicle in which the violator rides from an image captured by a roadside camera;
a personal information acquiring unit configured to acquire personal information correlated with the vehicle identification information from a database which is provided in a system that is configured to provide services for vehicles; and
an output unit configured to output violation information in which the image and the personal information are correlated.

2. The violator identification device according to claim 1, wherein the personal information acquiring unit is configured to request the database to provide the personal information correlated with the vehicle identification information.

3. The violator identification device according to claim 1, wherein the image includes a face image of the violator.

4. The violator identification device according to claim 1, further comprising a violation detecting unit configured to detect violation of the vehicle on the basis of a measurement result including at least one of speed, weight, height, and length of the vehicle measured by a sensor.

5. The violator identification device according to claim 4, wherein the output unit is configured to output the violation information further including the measurement result measured by the sensor.

6. A violator identification system that is configured to identify a violator associated with travel of a vehicle, the violator identification system comprising:
a roadside camera configured to capture an image including the violator and the vehicle in which the violator rides; and
a violator identification device according to claim 1.

7. A violator identification method of identifying a violator associated with travel of a vehicle, the violator identification device comprising:
a vehicle identification information acquiring step of acquiring vehicle identification information which is able to identify the vehicle in which the violator rides from an image captured by a roadside camera;
a personal information acquiring step of acquiring personal information correlated with the vehicle identification information from a database which is provided in a system that is configured to provide services for vehicles; and
an output step of outputting violation information in which the image and the personal information are correlated.

8. A non-transitory computer readable medium storing a program causing a computer of a violator identification device that is configured to identify a violator associated with travel of a vehicle to perform:
a vehicle identification information acquiring step of acquiring vehicle identification information which is able to identify the vehicle in which the violator rides from an image captured by a roadside camera;
a personal information acquiring step of acquiring personal information correlated with the vehicle identification information from a database which is provided in a system that is configured to provide services for vehicles; and
an output step of outputting violation information in which the image and the personal information are correlated.
